(19) United States
(12) Patent Application Publication
(10) Pub. No.: US 2008/0000122 A1
(43) Pub. Date: Jan. 3, 2008

(54) System and methods permitting the display of images, text and messages on a network of electronic paper-like displays in indoor modular signs

(75) Inventor: Neil Shotton, Perry, FL (US)

Correspondence Address: STAAS & HALSEY LLP, SUITE 700, 1201 NEW YORK AVENUE, N.W., WASHINGTON, DC, 20005, US

(73) Assignee: The SAMSON GROUP, LLC, Brewton, AL (US)

(21) Appl. No.: 11/806,652

(22) Filed: Jun. 1, 2007

Related U.S. Application Data
(60) Provisional application No. 60/810,504, filed on Jun. 3, 2006.

(51) Int. Cl. G09F 7/00

(52) U.S. Cl. 40/605

(57) ABSTRACT

Provided is a system and corresponding methods for a network of indoor modular signs. The indoor signs are composed of various modules which are combined to make the signs fully contained and operable. The modules include paper and e-paper based displays and frames as well as power line communication devices. The invention includes: a network of modular signs within an indoor area, a computing station with prerecorded data, and said data is presented as scheduled on the electronic paper-like display modules and power line communication networks that provide both power and data to the displays.

### CROSS-REFERENCE TO RELATED APPLICATIONS

This application claims the benefit of U.S. Provisional Application No. 60/810,504, filed Jun. 3, 2006, the disclosure of which is incorporated herein by reference.

### BACKGROUND

1. Field of Invention

This invention generally relates to methods, systems and apparatus to display images, text and messages on indoor, emissive or reflective e-paper or paper-like displays. More particularly, the invention relates to providing advertising and wayfinding messages using a network of lightweight e-paper displays within well defined indoor areas, such as hanging from the ceiling at the start and end of each store aisle, and the associated system that allows advertisers, marketers and others to place advertisements and messaging on these displays and network the displays so that the advertisement and wayfinding information is visible by consumers walking through these well-defined areas.

2. Description of the Related Art

Electronic signage used as an advertising medium is commonly deployed in retail outlets and stores to display advertising material and the like utilizing a variety of electronic display technologies and traditional paper or plastic signs to provide wayfinding information to customers within a particular area of a store.

Wayfinding signs provide store navigation information to customers. These signs are lightweight and static, and are made of plastic, paper or similar material. They most often hang from the ceilings of stores. Customers looking at these signs know what department area they are in or near, such as women's clothing, pets, hardware, domestics, electronics, etc. For grocery aisles, these signs will provide the aisle number and list the products and items found in the aisle.

There are numerous problems with static signs being used to provide store navigation information. New products and items cannot be quickly or easily added to the signs. The size of the font cannot be easily changed and it is impossible to use the sign to highlight specific brand items within a department.

Indoor electronic signage used for advertisement utilizes LED, plasma and LCD flat-screen displays as well as television and other technologies that emit light which is seen by the individual viewing the display. These are called emissive display technologies because they emit light and the advertisement and information systems that use these technologies are often referred to as “narrow casting” systems and digital signage. An example is the television system that displays in-store advertisements in WAL-MART® stores. Use of indoor emissive displays is undergoing rapid growth and companies are adding electronic displays to multiple outlets to increase advertising reach and to influence buyers. The content of the signs can be electronically changed based upon the needs and desires of the advertising company. Small, emissive display screens are being increasingly used within stores to provide advertisement and product information.

Despite the technical advances in emissive displays and narrow casting technology there are numerous problems with this approach to indoor advertisement. One problem is the very high cost of bright, high quality LED systems and other electronic displays. Another significant problem is the weight of emissive displays. Specifically, LED, plasma, and LCD flat-screen displays as well as television and other similar display technologies all are heavy due to the electronics package required for emissive displays.

These problems limit the ability to use a large number of emissive displays within a small, well-defined area and significantly limit the placement of the screens and prevents electronic signs from being used as store navigation wayfinding signs.

Another drawback with the current art in indoor electronic signage is the high cost and complexity of installation. This cost and complexity prevents current digital signs in stores from being used for both wayfinding and advertising.

In sum, there is no apparatus, system design or methodology which would allow electronic signage to be deployed in a concentrated number within a well defined area within a store or retail outlet for store navigation and for advertisement at or, extremely close to, the purchase point.

Neither is there an apparatus, system design or methodology which would allow deployment of indoor digital signs that would provide both navigation information and advertisement on the same sign. Such a system would greatly increase advertising effectiveness.

### SUMMARY OF INVENTION

Accordingly, an apparatus, system design or methodology to deploy numerous indoor digital signs within a well-defined area of a store or retail outlet and capable of being used for both wayfinding and product advertisement would have significant advantages over existing designs.

Accordingly, it is an aspect of present invention to address the deficiencies in the related art and make possible the deployment of numerous networked, indoor digital signs within a defined area.

It is another aspect of the present invention to deploy numerous indoor digital signs that are extremely lightweight within a well defined area and utilizing the displays for either advertisements or wayfinding messages or both.

Additional aspects and/or advantages will be set forth in part in the description which follows and, in part, will be apparent from the description, or may be learned by practice of the invention.

The foregoing, and/or other aspects are achieved by providing a modular sign, comprising: a first electronic paper-like display to display information.

The foregoing, and/or other aspects are achieved by providing a network, comprising: a first modular sign comprising a paper-like display to display first information; and a second modular sign comprising a paper-like display to display second information.

The foregoing, and/or other aspects are achieved by providing a method, comprising: providing first and second modular signs, each of the modular signs comprising a paper-like display; transmitting the information via a network to the first and second modular signs; and displaying the transmitted information on the first and second modular signs.

Accordingly, it is another aspect of the present invention to provide modules that, when put together, make an extremely light weight and easily installed indoor electronic sign that can be hung from the ceiling of retail outlets to provide product advertisement, wayfinding information or both.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an illustration of the modules of one embodiment of the modular sign according to an embodiment of the present invention;

FIGS. 2a and 2b show front and back views of the modular sign of FIG. 1;

FIG. 3 illustrates a second alternative embodiment of the present modular sign used as a wayfinding sign;

FIG. 4 shows the second embodiment as used for advertising;

FIG. 5 shows the modules of the modular sign of FIG. 1 hanging from the ceiling;

FIG. 6 shows the system used to control messages on the modular sign of FIG. 1; and

FIG. 7 shows how the system and modular sign of FIG. 1 will be used.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents. Also, the phraseology and terminology used herein is for the purpose of description and should not be regarded as limiting. The invention is capable of other embodiments and of being practiced or of being carried out in various ways.

The present invention is intended to, for example display advertisement and wayfinding messaging or a combination of both wayfinding information and advertisements using numerous indoor modular signs containing electronic paper-like displays and located within a well defined in-store area such as the store aisle or a department within a retail outlet. The present invention is also directed to a method and system through which a retailer or advertiser can provide advertisements or wayfinding information or a combination of both advertisement and wayfinding information using numerous indoor modular signs within a well defined area, such as a store aisle or store department.

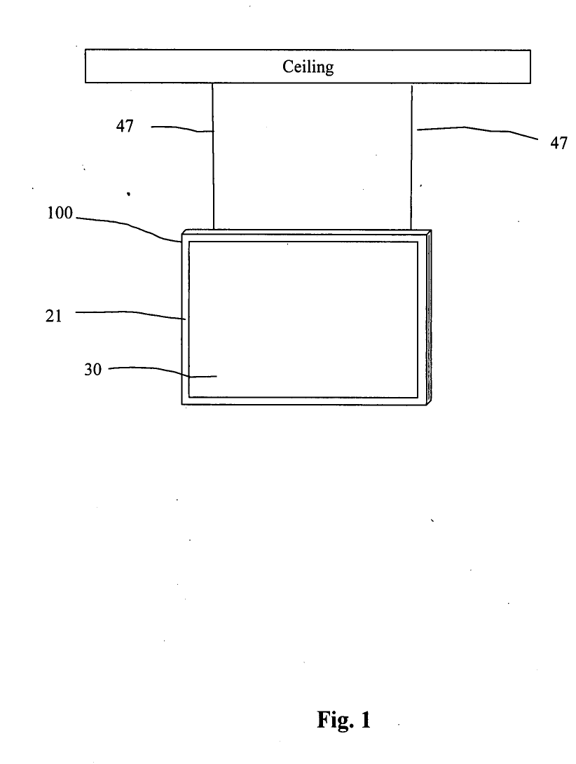

Referring to FIG. 1, there is shown a modular sign 100 containing an electronic paper-like display 30 which may exhibit images, video, text and messages used to advertise or to provide wayfinding information. The display 30 may, for example, take the form of an electronic paper-like display mounted within a 3 feet by 2 feet side of a frame 21 of the modular sign 100 and providing a viewing area of 33 inches by 21 inches. The frame 21 is the supporting structure for the modules that make up the modular sign 100.

Electronic paper-like displays 30 represent a category of display that use low power and are made of lightweight, flexible material, most often a plastic material, on which text and images can be displayed and electronically changed. The displays can be reflective, just like real paper, meaning that they can be used in broad daylight or under in-store lighting condition and be easily read. Also, the displays can be emissive, meaning light is output to make the sign readable. Also, the displays have a very wide viewing angle.

There are a variety of technologies that can be used to create an electronic paper-like display including light emitting polymer, organic electro-luminescence, organic light emitting displays (OLED), suspended particle device technology, electrophoretic and reverse electrophoretic emulsion display material, bistable nematic technology, high resolution electronic ink, cholesteric and encapsulated cholesteric display materials, electrochromic material, nanotechnology-based materials such as quantum dots, carbon nanotubes or nano-emissive materials, displays printed with various layers of conductive ink, nano ink, nano-metallic ink, carbon nanotube ink, and molecular bistable displays. However, these are just examples and other technologies may be used. These displays can be placed on many different lightweight materials such as plastic, paper and canvas.

Suitable paper-like display material for the display 30 is manufactured by, for example, E-Ink Corporation of Cambridge, Mass., USA, ZDB in the United Kingdom, Xerox Corporation, Samsung, Fujitsu, Kent Display, Quantum Paper and Bridgestone.

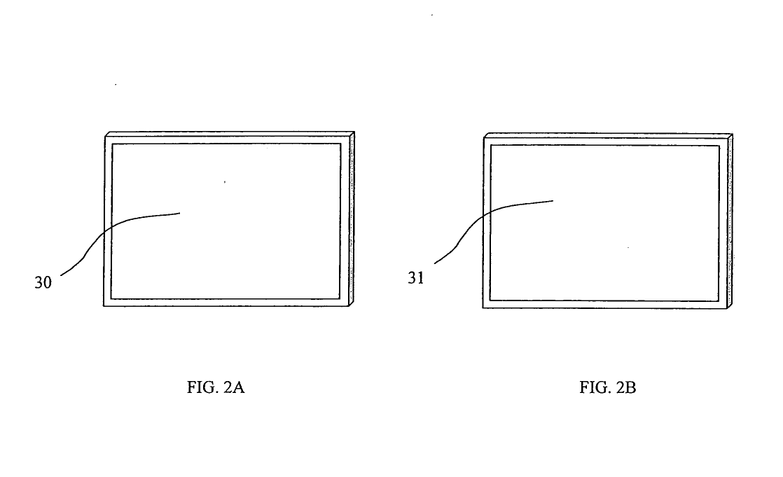

As shown in FIGS. 2a and 2b, another display 31 is on the opposite side from the display 30. Thus, the modular sign 100 contains two electronic paper-like displays 30 and 31. The displays 30 and 31 may be identical. In this manner, advertisement and wayfinding information is available to be seen by more shoppers within a store.

Electronic paper is lightweight, flexible, and inexpensive and has very low power requirements. The light weight of the electronic paper-like displays 30 and 31 allows the modular sign 100 to be mounted on existing infrastructure, display racks, shelves or hung from the ceiling.

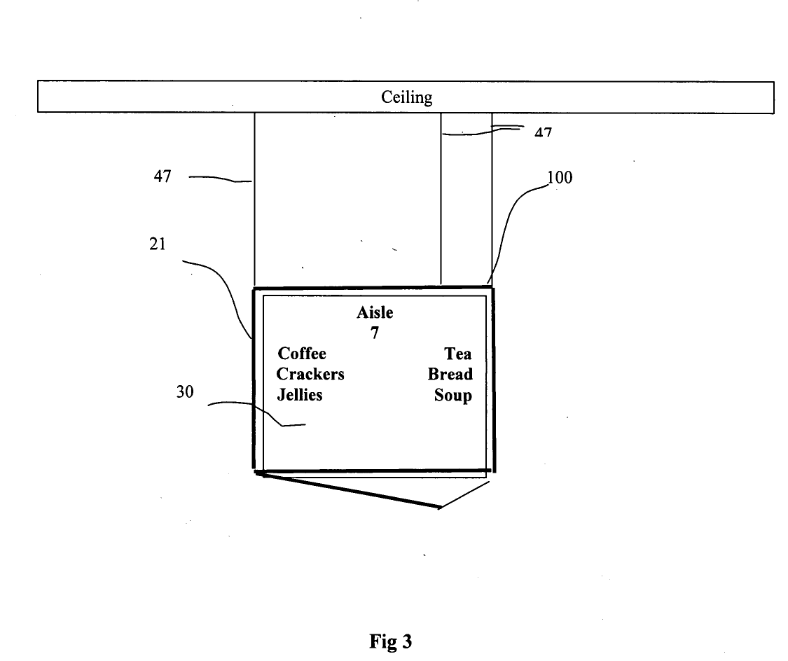

FIG. 3 illustrates a second embodiment of the modular sign 100. The sign 100 is triangular in shape and has a three sided frame 21 and three of the electronic paper-like displays 30 and thereby providing more viewing areas, e.g., three advertising displays per modular sign 100. This embodiment of the invention may be placed at the start and end of a store shopping aisle where triangular wayfinding signs are often found. Customers approaching the aisle from various directions can see the sign and the information and advertisements it contains. Wayfinding information can be shown on one display 30 while advertisement can be shown on the other display 31.

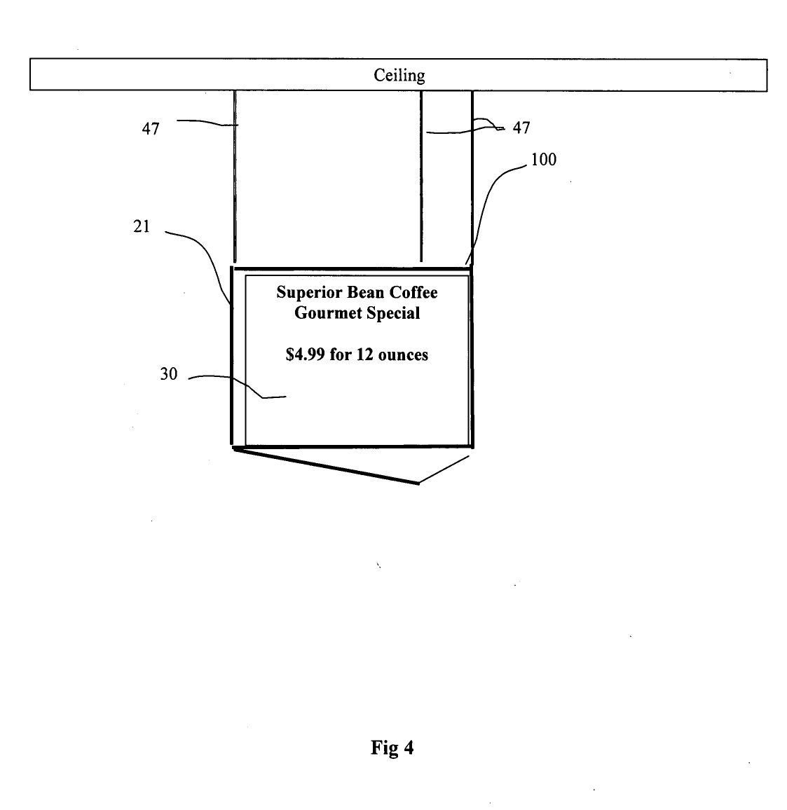

FIG. 4 illustrates the dual nature of the modular sign 100 showing a different message being flashed on the display as opposed to FIG. 3. Specifically, the display of FIG. 3 shows the products found in aisle 7, one of these products being coffee. FIG. 4 shows how a coffee advertisement can be displayed on the sign for consumers that are moving down that aisle. FIG. 3 and FIG. 4 have the same structure as the modular sign 100, switching from a wayfinding display in FIG. 3 to an advertisement in FIG. 4.

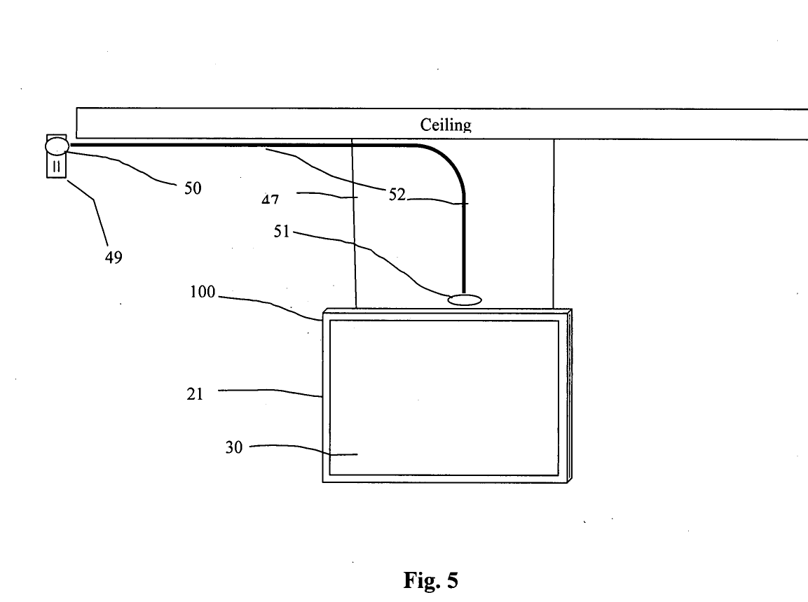

FIG. 5 illustrates how the modular sign 100 may be connected to power and data. Power line communication devices 50, 51 are respectively plugged into a wall electrical outlet 49 and into the display 30. The power line communication technology allows a power line to act as a signal transmission channel. In this manner, both power and data can move over the electrical wires that are part of the store's infrastructure, through the wall outlet 49, over an electrical cord 52 strung between the communication device 50 and the display device 30. Power line communication devices are extremely low cost and can be purchased from companies such as Asoka Corp., Philips, Actiontec, Linksys Group, Netgear and Siemens.

The relative light weight of the electronic paper-like displays 30, 31, the frame 21, the power line communication devices 50, 51, and the electrical cord 52 allows the modular sign 100 to be easily and safely hung from the store ceiling using wire cable 47 similar to the cable used to hang conventional signs. The embodiments shown in FIGS. 1, 2, and 3 will be hung from the store ceiling and have data and power provided though the powerline communication devices 50, 51.

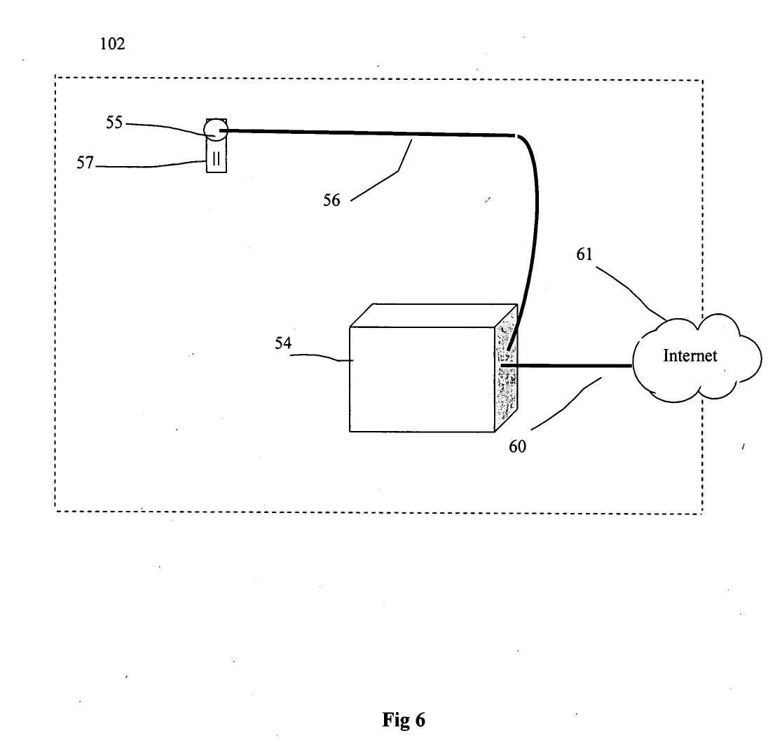

FIG. 6 illustrates the operation of the modular sign 100. A system 102 includes a server or computer 54, a power line communications router device 55, and an Ethernet cable 56. The router device 55 is plugged into an electrical wall socket 57. The Ethernet cable 56 connects the computer 54 to the power line communication router device 55. Commercially available software within the computer 54 will transmit and manage advertisement or wayfinding information over the store electrical wiring system to the displays 30, 31 via the Ethernet cable 56, the power line communications router device 55, the power line communication device 50 and the electrical outlet 49. The computer 54 is connected to a network 61 such as the internet though a wired connection 60.

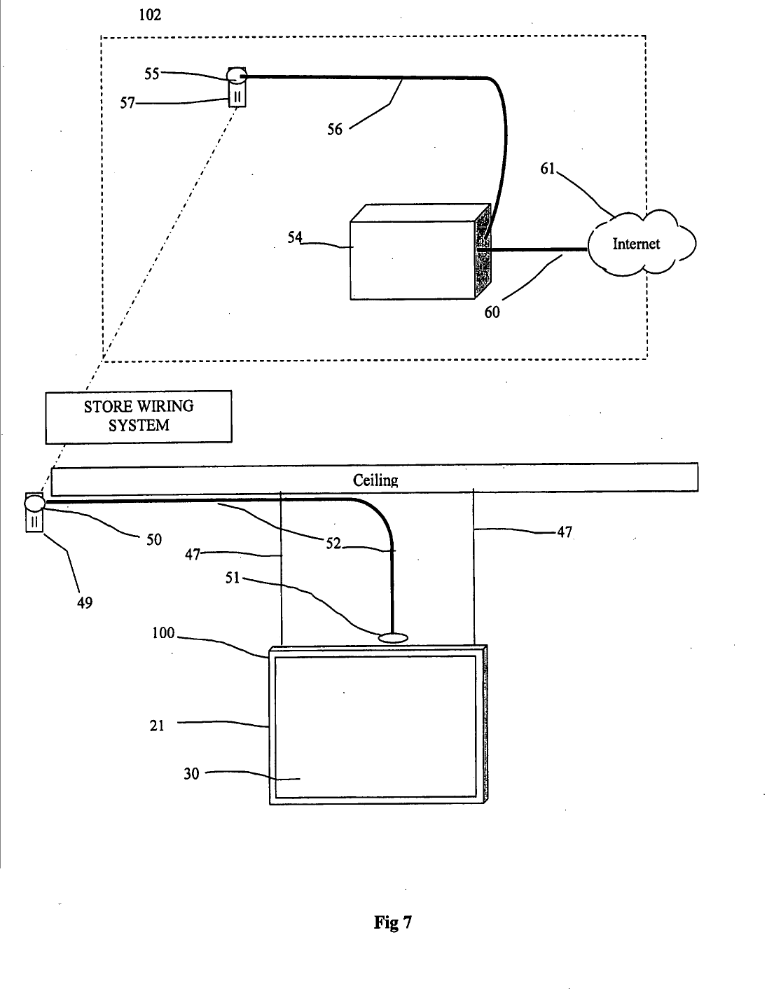

In the example shown in FIG. 7, the system 102 may be placed in any location of a store, such as an office or the back store room. The computer 54 uses commercially available software to send data on wayfinding messages and advertisements through the Ethernet cable 56 to the power line communications router device 55 and into the store's electrical wiring system through the electrical outlet 49. A plurality of the modular signs 100 may be hung from the ceiling throughout the store using standard, light gauge cable 47. The modular sign 100 uses power line communication devices 50, 51 connected with the commercial electrical cord 52. A power line communication device 50 plugged into the electrical outlet 49 provides a communication channel for the data that is in the store electrical wiring system. In this manner, the system 102 is able to input and control the data that goes into the modular sign 100. This arrangement allows the system 102 to place images and text for wayfinding information or for advertisement onto the paper-like display 30.

The present invention provides the low power, high resolution and wide angle viewing, compactness and modularity of a conventional printed sign module with the ability to change the images and text on the electronic paper-like display 30 through the existing electrical systems by using power line communication devices 50, 51 and 55.

Referring to the drawings, there is shown a system 102 for direct placement of wayfinding information, commercial advertisements, public service announcements and other content onto a plurality of electronic paper-like displays 30 that are each part of the modular sign 100.

System 102 includes a network comprising a plurality of electronic paper-like displays 30 that are located within a well defined in-store area such as the various departments or within or near shopping aisles. A large number of modular signs may be deployed within each defined area and the plurality of electronic paper-like displays 30 within each modular sign 100 are networked and controlled through the store's electrical wiring that is located within each area by using power line communication devices 50, 51, 55.

System 102 may be connected to a network such as the internet 61 and is capable of receiving advertisements and other information from a location that is removed from the store.

System 102 may be located at many different and separate stores, such as all the stores of a certain size within a metropolitan area, may have a customer such as a consumer products company or an advertising agency that purchase time on the system 102. Each purchased time slot represents time that an advertisement with text and image or other messages will be displayed on the network of a plurality of electronic paper-like displays 30. The computer 54 within the system 102 controls the time allocation on the electronic paper-like display 30. Data on new content and time slots is provided to the computer 54 via the internet 61.

As schedule changes occur based upon new content and time schedules, the system 102 will send the updates to the network of a plurality of electronic paper-like displays 30 which receive this data through the store's electrical system via the power line communication devices 50, 51, 55.

Customer content, time schedules and deployment areas are provided to the system 102 based upon contracts which specify the requirements for the appropriate operation to be carried out.

Those skilled in the art will understand that the preceding embodiments of the modular sign 100 provide the foundation for numerous alternatives and modifications thereto. For example, the display modules may include the use of very thin LCD and very low power LCD displays as a module. Other modifications may include the use of flexible OTFT-LCD (organic thin film transistor-liquid crystal display), polythiophene-based semiconductive ink, carbon-nano-tube technology, nano-electronics, nano-powder, high resolution electronic ink, cholesteric and encapsulated cholesteric display materials, electrochromic material, nanotechnology-based materials such as quantum dots, carbon nanotubes or nano-emissive materials, displays printed with various layers of conductive ink, nano ink, nano-metallic ink, carbon nanotube ink, and molecular bistable displays and other types of very thin, lightweight displays. These other modifications are also within the scope of the present invention. Accordingly, the modular sign is not limited to that precisely as shown and described in the present application. Data connections to the modular sign 100 may be made with wireless connections, standard Ethernet cable and through other means than powerline communications. Accordingly, the system 102 is not limited to that precisely as shown and described in the present application.

The invention uses either emissive or reflective electronic paper-like display technology which is low cost, very light weight and has very low power requirements. This allows a modular sign to be deployed where the modules are electronic paper-like displays, power and data devices, and the sign frame. The modular signs can easily be installed on existing infrastructure such as clothing racks, product display racks, product shelves, the wall behind merchandise shelves or, most commonly, hung from the store ceiling to create a new category of indoor networked digital signage based upon paper-like or e-paper display technology. These paper-like indoor signage modules deliver reinforced advertising and wayfinding information or a combination of advertising and wayfinding information to consumers walking through the store area or down the aisle where these modular signs are deployed. The lightweight nature of the signs allows them to be hung from store ceilings, where they are easily visible and can be deployed in a greater density.

The present invention is therefore novel in its application of indoor signage technology, and unique in its capabilities, in that it addresses all of the requirements for deployment of numerous indoor signage within a defined area and using these signs to deliver product advertisement, wayfinding information or a combination of both in a manner not addressed by the related art.

A first non-limiting advantage of the present invention is that it provides systems and methods for displaying images, text and messages over a network of a plurality of modular signs in a well defined area within a store or retail outlet. Each sign having modules that may contain reflective or emissive electronic paper-like displays, battery packs, wireless ports, powerline communication devices and frames for holding the displays.

The lightweight displays may be reflective, meaning that in various conditions of light and brightness they appear with the same clarity as standard ink or paint on a conventional sign or they may be emissive meaning that they give off light providing luminance to the display. The displays also have a very wide viewing angle. The images, text, wayfinding information and advertisements displayed on the reflective electronic paper-like displays can be changed wirelessly or through the use of power line communication devices.

The modular signs are fully contained and are very light weight, allowing them to be mounted on existing infrastructure or hung from the ceiling. It is easy to build the modules in different sizes and shapes allowing a high density of signs to be placed in close proximity to each other in an in-store area such as an aisle or department. Advertisements are easily updated and changed, wayfinding information, such as the addition of new products within a department or on an aisle, can be easily changed.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A modular sign, comprising:
a first electronic paper-like display to display information.

2. The modular sign of claim 1, further comprising:
a second electronic paper-like display on a rear side of the first electronic paper-like display.

3. The modular sign of claim 2, further comprising a third electronic paper-like display, the first, second and third electronic paper-like displays being arranged in a triangle.

4. The modular sign of claim 1, wherein the first electronic paper-like display is a reflective display.

5. The modular sign of claim 1, wherein the first electronic paper-like display is an emissive display.

6. A network, comprising:
a first modular sign comprising a paper-like display to display first information; and
a second modular sign comprising a paper-like display to display second information.

7. The network of claim 6, further comprising
a powerline to provide power to the first and second modular signs; and
a plurality of powerline communication devices to communicate the first and second information to the first and second modular signs via the powerline.

8. The network of claim 7, wherein the first and second information comprises advertising information.

9. The network of claim 7, wherein the first and second information comprises wayfinding information.

10. The network of claim 7, further comprising a computer to control the communication of the first and second information.

11. The network of claim 7, wherein the powerline is an electrical wiring system for a building.

12. The network of claim 7, wherein the first and second modular signs are hung from a ceiling, the network further comprising a plurality of wires to support the first and second modular signs from the ceiling.

13. A method, comprising:
providing first and second modular signs, each of the modular signs comprising a paper-like display;
transmitting information via a network to the first and second modular signs; and
displaying the transmitted information on the first and second modular signs.

14. The method of claim 13, wherein the transmitting the information comprises transmitting via an electrical wiring system.

15. The method of claim 13, wherein the providing the first and second modular signs comprises providing the first and second modular signs in a store.

16. The method of claim 15, wherein the transmitting the information comprises transmitting advertising or wayfinding information.

17. The method of claim 15, further comprising hanging the signs from a ceiling of the store.

18. The method of claim 16, wherein the displaying comprises displaying the advertising information on the first modular sign and displaying the wayfinding information on the second modular sign.

19. The method of claim 14, further comprising:
providing a router at a first end of the electrical wiring system; and
providing a powerline communication device at a second end of the electrical wiring system; and
transmitting the information from the router to the powerline communication device via the electrical wiring system.

20. The method of claim 19, further comprising transmitting the information from the powerline communication device to the first and second modular signs.
